(19) United States
(12) Patent Application Publication
(10) Pub. No.: US 2021/0241210 A1
(43) Pub. Date: Aug. 5, 2021

(54) SYSTEMS AND METHODS FOR FACILITATING SELF-SERVE TRANSACTIONS WITH A FREEZER

(71) Applicant: QSRR Corporation (dba BeMeals), Hallandale Beach, FL (US)

(72) Inventor: Michael Esrubilsky, Coral Gables, FL (US)

(21) Appl. No.: 16/779,359

(22) Filed: Jan. 31, 2020

(51) Int. Cl. G06Q 10/08; G06F 16/23; G06Q 20/18; G06Q 30/00; G06Q 20/20; G06Q 20/10; G06K 7/10; H04L 12/18

(52) U.S. Cl. CPC G06Q 10/087; G06F 16/2379; G06Q 20/18; G06Q 30/0185; F25D 29/008; G06Q 20/102; G06K 7/10366; H04L 12/1895; G06Q 20/209

(57) ABSTRACT

Systems and methods for conducting self-serve transactions from an item storage device are described. In one embodiment, the system includes a freezer computing system that can execute instructions to receive an unlock signal, unlock a door of the freezer, receive an indication that the door is closed, direct one or more scanners to conduct a scan of the freezer to generate an inventory, receive the inventory from the one or more scanners, and send the inventory to a server. In another embodiment, the system includes a server computing system that can execute instructions to receive a freezer identifier and a purchaser identifier from a purchaser device, verify the freezer identifier to ensure that the purchaser is interacting with a valid freezer, verify the purchaser identifier to ensure that the purchaser is authorized for transactions, send an unlock signal to the freezer, and receive an inventory message from the freezer.

### BACKGROUND

A busy work schedule can lead to cutting corners in other areas of our lives. One of the first things to be reduced is often the time allocated to eating. Professionals attempting to maximize their output often respond by turning to fast food, eating snacks from a vending machine, putting meals off until a project is completed, or skipping meals entirely. This can lead to bad nutrition and poor health in employees, reducing well-being and overall satisfaction. Partly to address this problem while maximizing output from their employees, larger companies often offer cafeteria services within the office. Cafeterias can reduce the time lost to employees traveling to and from food sources, while providing access to meals to combat malnutrition. But this solution is limited by the large cost of offering a cafeteria and by the fact that the cafeteria may be able to provide employees with meals only during certain hours. Further, smaller companies may not be able to offer a cafeteria or other source of meals at all. Accordingly, a solution offering on-demand meals at any hour at a low cost for the employer is desirable.

### BRIEF DESCRIPTION OF THE DRAWINGS

FIG. 1 is a block diagram of a representative ITC system in which aspects of the described technology may operate.

FIG. 2 is a transaction diagram illustrating the data flow between components of the ITC system in some embodiments.

FIG. 3 is a flow diagram of a component for authorizing a transaction with the freezer in some embodiments of the ITC system.

FIG. 4 is a flow diagram of a component for managing a transaction with the freezer in some embodiments of the ITC system.

FIG. 5 is a flow diagram of a component for tracking a freezer's inventory in some embodiments of the ITC system.

FIG. 6 is a flow diagram of a component for checking whether to restock the freezer in some embodiments of the ITC system.

FIG. 7 is a flow diagram of a component for determining what items to include in a restocking shipment inventory in some embodiments of the ITC system.

FIG. 8 is a flow diagram of a component for conducting a continuous scan inventory in some embodiments of the ITC system.

FIG. 9 is a flow diagram of a component for processing the inventory results from a continuous scan inventory in some embodiments of the ITC system.

FIG. 10 is a flow diagram illustrating a component for checking for expired items in some embodiments of the ITC system.

FIG. 11 is a flow diagram illustrating a component for checking for added items in some embodiments of the ITC system.

FIG. 12 is a flow diagram illustrating a component for checking for removed items in the freezer inventory in some embodiments of the ITC system.

### DETAILED DESCRIPTION

Methods and systems for managing a self-serve item transaction from an item storage device are provided. In some embodiments, an item transaction control (ITC) system employs various computing systems and applications to coordinate the purchase of self-serve items (e.g., a meal) from an item storage device (e.g., a freezer). The ITC system may provide a purchaser application, a server application, and an item storage device application that help ensure the integrity of the transactions (e.g., by detecting theft), safety of the items (e.g., by detecting spoilage and possible tampering), proper inventory management, and so on. A purchaser interacting with the purchaser application that is executing on a purchaser device (e.g., smartphone) is provided an identification of the item storage device (e.g., QR code) from which the purchaser wants to purchase an item. The purchaser application then sends an identification of the purchaser and the identification of the item storage device to the server application. The server application ensures that the purchaser is authorized to purchase an item from the identified item storage device. If the purchaser is authorized, the server application notifies the item storage device application executing on a computing device associated with the item storage device that an item is to be purchased. The item storage device application directs that the item storage device be unlocked so that the purchaser can remove a desired item. The purchaser then opens the item storage device (or it may open automatically), removes the desired item, and closes the item storage device, resulting in locking of the item storage device. The item storage device application interfaces with an inventory device (e.g., one or more scanners, such as a radio-frequency identification (RFID) scanner) that generates an inventory of items (e.g., having RFID tags) stored in the item storage device. The inventory device provides (e.g., periodically or when the item storage device is closed) the item storage device application with the inventory in the item storage device. The item storage device application sends an indication of the inventory to the server application. The server application can compare the inventory with a previous inventory to identify the item that the purchaser removed and charge an account (e.g., credit card account, Apple Pay accounts, Google Pay accounts, Venmo accounts, PayPal accounts, and various other payment accounts) for the item.

In the following, the ITC system is described in the context of an item storage device that is a freezer storing meals and snacks (e.g. frozen lunch and/or dinner items, breakfast items, soups, desserts, and/or various snack items). However, the ITC system may be used with other types of item storage devices, such as refrigerators, devices that are not temperature-controlled, devices that may be used to store other items (other than meals), and so on. The purchaser application, server application, and freezer application refer to the collection of computer code that executes on a purchaser device, a server, and a freezer device, respectively. Also, the ITC system may be configured so its functions can be handled by different applications. For example, the server application may coordinate charging an account of the purchaser after an item is purchased using payment information previously stored at the server (e.g. credit card information, Apple Pay accounts, Google Pay accounts, Venmo accounts, PayPal accounts, and various other means of payment). Alternatively, the purchaser application can coordinate the charging based on payment information accessible to the smartphone after receiving a notification from the server application to complete the transaction.

In some embodiments, the ITC system assigns a freezer identifier to each freezer. The ITC system uses the freezer identifier to identify which freezer a purchaser is interacting with. The freezer identifier may be a QR code that a purchaser can scan with a smartphone. Alternatively, the freezer identifier can be sent by the freezer application or the server application to the smartphone through some other wireless communication, such as via Bluetooth, internet messaging, SMS messaging, etc. As another alternative, the freezer identifier may be determined based on the GPS coordinates of the smartphone. The purchaser application then sends the freezer identifier (or GPS coordinates of the smartphone) along with a purchaser identifier to the server application. Upon receiving the identifiers, the server application verifies the identifiers. Verification can include, for example, checking that the purchase via the identified freezer can proceed (e.g., the freezer is not down, waiting to be serviced) and that the purchaser is registered and/or authorized in the system. If either identifier cannot be verified, the purchaser application may receive an error message from the server application and provide the error message to the purchaser indicating why the identifiers were not verified. The purchaser application can then prompt the purchaser to retry the purchase, ensure that the purchaser is registered in the system, rescan the freezer identifier, etc.

After validating the identifiers, the server sends, and the freezer receives, a signal to unlock a door to provide the purchaser access to inventory within the freezer, such as frozen meals, snacks, soups, desserts, etc. The purchaser may remove any number of items and then shut the door, resulting in the freezer and server completing the remainder of the transaction automatically. In some embodiments, the freezer door is on a self-closing hinge, such that the door will shut on its own when the purchaser walks away.

After the door is shut, the freezer application directs a scan of the contents using one or more scanners built in to the interior of the freezer. The scan generates an inventory of the items that remain in the freezer after the transaction. The inventory can then be sent to the server. Among other things, the server receives the current inventory, retrieves the inventory from the prior transaction, and compares the two. When the transaction is complete, the purchaser application may receive a notification from the server application and provide confirmation to the purchaser of the item purchased, the purchase price, and so on. The server can then charge the account of the purchaser for confirmed removed items and create a record of new inventory for use in the next transaction. In some embodiments, the server can directly charge a payment method registered to the purchaser's account. In other embodiments, the server can add the charge information to a bill, paid later by the purchaser or by a freezer manager (e.g. an employer sponsoring items from the freezer). When paid by an employer, the server can provide purchaser identifiers to the freezer manager to allow, for example, an employer to track the purchases of employees. In still other embodiments, the server can a freezer manager (such as an employer) to partially subsidize items from the freezer. For example, employers can elect subsidies that can be set by an amount of meals a purchaser can remove from the freezer (e.g. 10 free items, or 4 items per week), a percentage of an item's cost (e.g. 50% off an item), a specific price discount (e.g. $2.00 off any item, or $2.00 off a selected item), and/or some combination therein (e.g. 2 items per week at a 50% discount).

Further, in some embodiments, the inventory generated by the freezer can include information allowing the server to identify items added to the freezer. In one embodiment, for example, if the inventory generated by the freezer comprises a list of RFID tags present in the freezer, the server can detect items added to the freezer by analyzing the inventory for RFID tags that were not present in the previous inventory. Further, the added RFID tag can allow the server to detect an item that was previously removed and reinserted into the freezer, for example by detecting that the tag was not present on the immediately previous inventory but was present on an older inventory. This detection can, for example, help identify items that have potentially been tampered with. Once the item is detected, the server can identify the item using the RFID tag (e.g., it can identify the type of item, identify a label on the packaging, etc.). That identification can be used to send an alert to purchasers before and/or after they remove the potentially tampered item from the freezer and send an alert to the freezer manager to check and/or remove the items.

In another embodiment, the inventory can include more measurements of the interior of the freezer, such as weight detected on shelves, information relayed from computer vision within the freezer, images of the interior, and/or other information, to allow the server to detect non-tagged items, such as items foreign to the freezer system. Any detected items can then be identified based on the information used to detect them (e.g., non-RFID item on third shelf) in an alert sent to a purchaser and the freezer manager. In still other embodiments, the server can use the record of the inventory to perform various other functions.

Beyond identifying added and/or removed items, the server can execute various other functions using the inventory. In one embodiment, the server can monitor the need for and/or manage restocking. For example, the server can run a restock algorithm when it receives a new inventory. The restock algorithm can check the inventory and selectively fill a shipment to restock the freezer based on which items are selling faster or are more likely to need to be restocked soon. Additionally, or alternatively, the restock algorithm can fill a shipment to restock the freezer with items that have not yet been sent to the freezer in order to, for example, generate item-variety in the freezer and introduce newly created items into the freezer. Further, the server can train a machine learning algorithm based on the history of purchases, history of inventories, purchaser demographics, time of year, and so on so that the machine learning algorithm can use when deciding when and what items to restock. In another embodiment, the server can check the inventory for items left in the freezer past a designated consumption date. If any items remain past their consumption date, the server can communicate a “do not consume” alert to a purchaser (e.g., send an alert to the purchaser application and/or send an alert to be displayed by the freezer) and send an alert to the freezer manager to remove the items. In another embodiment, the server can publish (e.g., to the purchaser application) a menu of items currently in a freezer so that a person can decide whether to make a purchase without having to open the freezer. The server can also publish nutritional information about the items, the ingredients of the items, any allergy warnings (e.g., contains peanuts) for an item, and so on. When the server detects that an item has been removed, the server may send cooking instructions for the item (e.g., microwave 10 minutes on high or press button B) to the purchaser application. The packaging of the item may also include the cooking instructions.

In some embodiments, the ITC system includes an oven to reheat items from the freezer. In some embodiments, the oven can include pre-programmed instructions that can be called and executed when a purchaser presses a single button on the oven corresponding to the instructions. For example, items may be packaged with a number (e.g. 1-9) such that when a purchaser presses a corresponding number-button on the oven, the oven will execute instructions to reheat the item. In some embodiments, the items can be packaged such that a purchaser does not need to open, poke holes in and/or rip the packaging, stir the contents, and/or do anything else to the item before placing the item in the oven. Further, in some embodiments, the oven can include one or more sensors (e.g. one or more RFID scanners) that can identify the item placed in the oven when a door to the oven is closed and automatically execute pre-programmed instructions to reheat the item based on the identification. In some embodiments, the oven is in communication with the freezer and/or server and can receive an item identifier and/or reheating instructions from the freezer and/or server and automatically execute instructions to reheat the item based on the identification.

In some embodiments, items in the freezer can be designed and packaged to help facilitate the reheating by the oven. For example, the items can have ingredients that are selected and arranged in the packaging based partly on their water density. In general, water's relatively high specific heat capacity causes ingredients with a higher water density to require more heat to reheat than ingredients with a lower water density. To account for the different heating requirements, ingredients with a higher water density can be arranged on the borders of the packaging, where they will receive more heat, while ingredients with lower water density are arranged in the center. Taking the water density of ingredients into account in this way helps ensure ingredients are heated relatively uniformly. That is, items can be packaged to avoid ingredients burning before others are reheated. Further, considering water density this way allows items to be packaged such that a purchaser does not need to stir the meal (e.g. remove the meal from the oven and stir halfway through reheating) until or unless they want to mix the ingredients.

In some embodiments, the packaging design, packaging materials, and oven cycles can also be designed to increase the convenience of using the system. For example, the packaging may be rounded (e.g. circular, ovular, has rounded corners, etc.) improve uniformity of exposure to heat from the oven and to improve heat conduction within the item while reheating. For example, packaging with sharper corners can expose ingredients in the corner to heat from the oven on two sides as opposed to one, while isolating the ingredient from convection with the interior ingredients. The packaging can use heat resistant containers to help avoid overexposing ingredients on the border during reheating and protect the purchaser from burns when removing the item from the oven. The packaging can be sealed to control humidity within the process for more efficient reheating of meals. In some embodiments, the packaging can include vents to disperse humidity (and heat) during reheating; while in other embodiments the packaging does not include vents, instead using the humidity in the reheating process. In some embodiments, the vents can be built into the packaging, allowing the purchaser to place the item in the oven without ripping, tearing, removing, or poking holes in the packaging. The oven can include cycles specific to items to help facilitate reheating. That is, the oven's pre-programmed cycles can be specifically designed for each item and can cycle through various amounts of heat being supplied to the packaging. For example, a microwave process in the oven could spend two minutes on a sixty-percent power setting to defrost ingredients slowly, then one minute on full power to complete reheating. The water density of the ingredients is used in creating the pre-programmed cycle for the item.

Various embodiments of the technology will now be described in more detail. The following description provides specific details for a thorough understanding. One skilled in the art will understand, however, that the described technology may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the technology.

### Overview

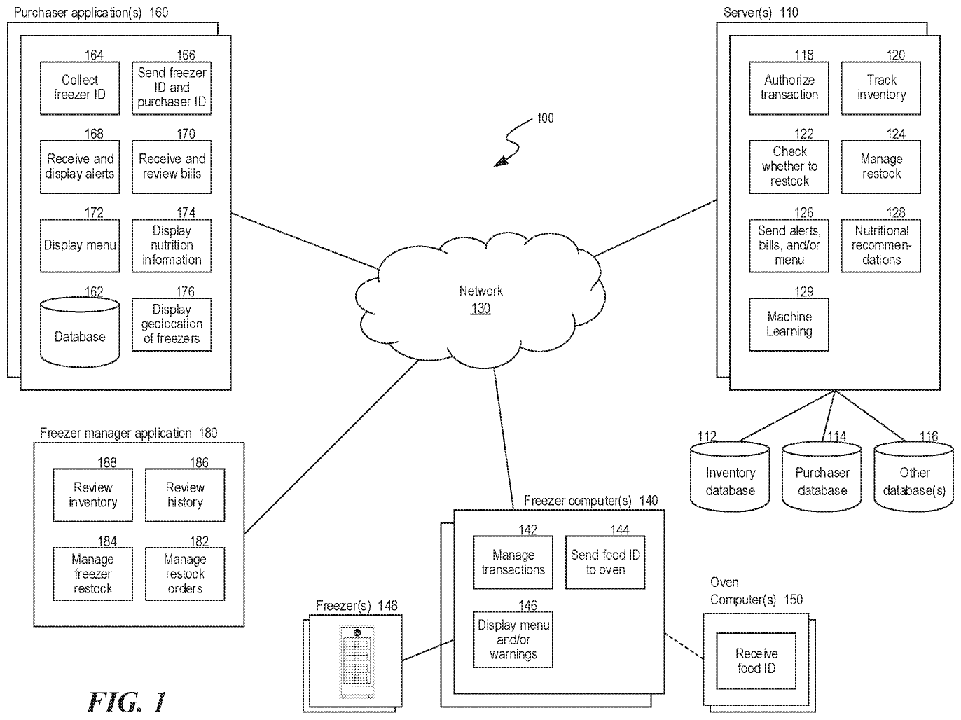

FIG. 1 is a block diagram of a representative ITC system 100 in which aspects of the described technology may operate. The ITC system 100 includes purchaser applications 160, servers 110, freezer computers 140, a freezer manager application 180, freezers 148, and so on. The servers may include an inventory database 112, a purchaser database 114, and one or more other databases 116. The inventory database stores inventory information for the inventory associated with each freezer. For example, the inventory information may contain the inventory status of a freezer after each transaction at the freezer, which can be used in other processes to charge purchasers, assess trends, manage restocking, etc.

The purchaser database 114 stores information related to the accounts associated with purchasers, such as purchaser identifiers for authorized purchaser accounts, and/or credit card or other payment information. Additionally, the purchaser database can store various demographic information, nutritional goals, allergies, etc., associated with purchasers, which can be used by the server to provide nutritional recommendations or allergy warnings.

The one or more other databases 116 can store nutritional information on items in freezer inventories, the ingredients in items, other system information, metadata, usage statistics for freezers, metadata on trends in purchases, and/or other information associated with the system. Although the inventory database, purchaser database, and other databases are depicted in FIG. 1 as separate databases, a single database and/or other combinations of databases may store the information necessary for the system in various other embodiments of the system.

As illustrated, the server can perform a variety of functions in service of the system's ability to enable self-serve transactions with a freezer. In particular, the server includes an authorize transaction component 118, a track inventory component 120, a check whether to restock a freezer component 122, a manage restock component 124, a send alerts, bills, and/or a menu for the freezer (comprised of the contents in the freezer) component 126, a nutritional recommendations component 128, and/or a machine learning component 129. These functions are discussed in more detail below.

The server communicates with one or more freezer computers 140 via a network 130. The freezer computer controls a freezer 148. The freezer includes a main compartment/interior, shelves within the interior for carrying inventory, one or more scanners in communication with the freezer computer, a door, a locking mechanism, and a communication element. The freezer computer 140 performs various functions to enable self-serve transactions with a freezer. In particular, the freezer computer includes a manage transactions component 142, and a display menu and/or warnings component 146. In order to execute the manage transactions component 142 at the freezer, the freezer computer communicates with various components of the freezer. Among other things, the freezer computer can communicate with the one or more scanners located inside of the freezer, the door of the freezer, and the lock to the door.

In some embodiments, the freezer computer can additionally include several components illustrated as executed by the server. For example, the freezer computer can include a track freezer inventory component, a check whether to restock a freezer component, etc.

In some embodiments, the freezer computer is in communication with an oven computer 150 and includes a component 144 in order to send food identification to the oven computer on the item removed from the freezer during a transaction to automate the cooking process.

The server also communicates with one or more purchaser applications 160 via the network. In one embodiment, the purchaser application is an application stored on a personal electronic device, such as a smartphone, that is coupled to a database 162 that houses a purchaser identifier and various other information, such as a catalog of freezer identifiers to allow purchasers to save the freezer identifiers in the purchaser application for quick access in the future and/or to support other purchaser application functions. As illustrated, the purchaser application includes a collect freezer ID component 164, a send freezer ID and purchaser ID component 166, a receive and display alerts component 168, a receive and review bills component 170, a display menu component 172, a display nutrition information component 174, and a display geolocation of freezers component 176. The collect freezer ID component may provide to the purchaser instructions to scan a QR code that is on the freezer and execute a scan of the QR code. The send freezer ID and purchaser ID component may provide to the purchaser instructions to send the freezer ID and purchaser ID to the server and execute instructions to send the same. The receive and display alerts component may receive various alerts from the freezer computer or server and display them to the purchaser. The receive and review bills component may receive information regarding removed items and provide to the purchaser instructions on confirming or challenging the same. The view menu component may request and receive information on the current inventory in the freezer and display to the purchaser the information. The view nutrition information component may request and receive information on the nutrition of items in the system and display to a purchaser the information. The display geolocation of freezers component may provide to the purchaser a display of a map showing the location of freezers in the system, as well as the geolocation of the purchaser, for reference.

The server and a freezer manager application 180 communicate with each other via the network. In some embodiments, the freezer manager (e.g., an employer) is responsible for the physical management of the freezer by restocking the freezer when shipments of items arrive. The freezer manager application may allow the freezer manager to manage the inventory of the freezer by, for example, allowing them to select the types of items to be included in the freezer, identifying when and what items to restock, providing restocking instructions generated by the server, and so on. A manage restock orders component 182 allows the freezer manager to alter the contents of a restocking shipment. This may be useful if, for example, the freezer manager knows that a frequent purchaser recently changed their diet and will be making different purchases from the freezer that the manager wants to account for. A manage freezer restock component 184 allows the freezer manager to confirm that shipments have arrived and submit reports on any problems with the shipment. A review history component 186 allows the freezer manager to review a history of the inventory in the freezer to manually review what items are being purchased. For example, the review history component can allow a company sponsoring a health event to track what items purchasers removed from the freezer and to confirm that purchasers made healthier choices. Finally, a review inventory component 188 allows the freezer manager to view the current inventory in the freezer. In some embodiments, the review inventory component can alert the freezer manager when items in the inventory need to be removed—for example, when items expire, when a new item has been placed in the freezer, etc. In other embodiments, the review inventory component can provide the freezer manager with a menu and nutritional information that the freezer manager can distribute to potential purchasers.

Although the purchaser application(s), the freezer manager application, and the freezer computer(s) are illustrated as being connected to the server via the same network, they may be connected to the server via one or more different networks.

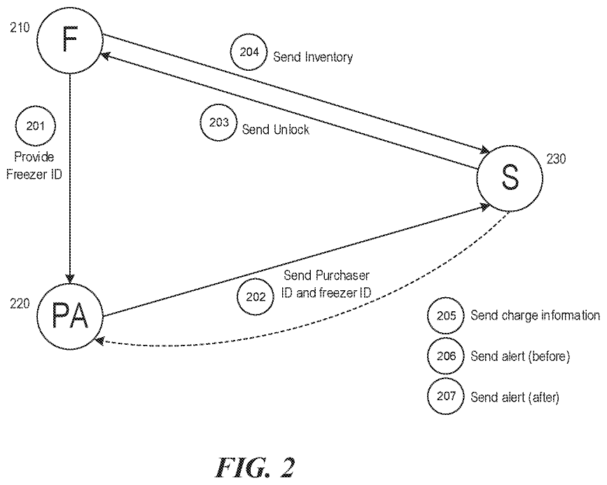

FIG. 2 is a transaction diagram illustrating the data flow between components of the ITC system in some embodiments. A freezer (F) 210 initially provides 201 a freezer identifier to a purchaser application (PA) 220. In one embodiment of the described technology, the freezer 210 provides the freezer identifier (ID) via a QR code visible on the outside of the freezer, which is read by the purchaser application via a camera that the purchaser application has access to. In other embodiments, the freezer ID can be communicated to the purchaser application through other wireless means such as Bluetooth, internet messaging, SMS messaging, etc. Alternatively, the freezer ID may be the GPS coordinates of the purchaser device. The purchaser application sends the freezer ID and a purchaser identifier (ID) 202 to a server (S) 230. The server receives and verifies the IDs to ensure that a freezer and purchaser exist and are authorized in the system, then sends an unlock 203 signal to the freezer associated with the freezer ID. When the freezer receives the unlock signal, the freezer unlocks a door, providing the purchaser access to the freezer's contents. The purchaser can open the door, remove desired items, and shut the door (or allow the door to shut). The freezer can then lock the door (which may be accomplished by an automatic mechanical structure), scan the freezer's contents to check for inventory, and send the inventory 204 to the server. After receiving the inventory, the server stores the information to update a record of the freezer's inventory.

In various other embodiments, the freezer may use the inventory to determine what items the purchaser removed, charge the purchaser, and send charge information 205 to the purchaser application so that the purchaser can review the charge. The server may also send an alert 206 to the purchaser application before sending an unlock message to the freezer, where the alert contains a warning to the purchaser not to consume an item. This alert may be useful, for example, when the server determines that a food item is past a safe consumption date, an item has been removed and placed back in the freezer, a food allergy is detected for the purchaser, and/or that a foreign object is present in the freezer. Additionally, or alternatively, the server can send the alert 207 to the purchaser after sending an unlock message to the freezer.

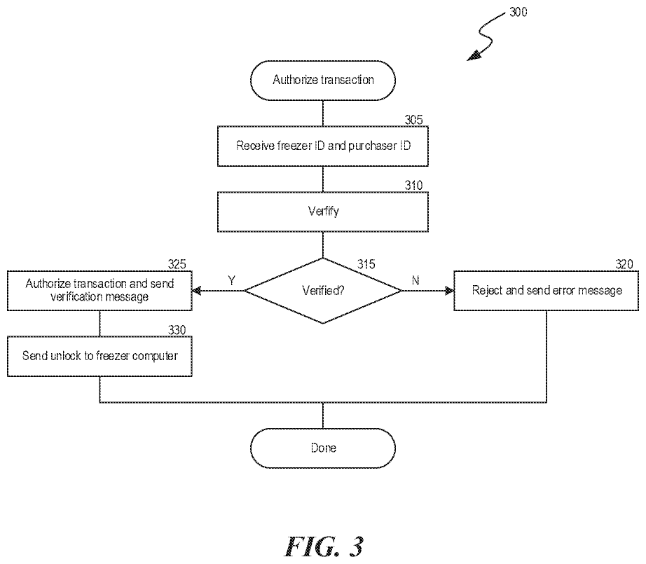

FIG. 3 is a flow diagram of a component for authorizing a transaction with the freezer in some embodiments of the ITC system. The authorize transaction component 300 can be executed by the server after a purchaser application sends the freezer ID and purchaser ID. In block 305, the component receives the freezer ID and purchaser ID. In block 310, the component verifies the identifiers by checking that the freezer ID corresponds to a freezer within the system and ensuring that the purchaser controlling the purchaser application is registered in the system and/or authorized to conduct transactions with the freezer. For example, by performing these verifications, the component can catch an error in the identifiers, flag a purchaser that has not completed necessary registration, or flag a delinquent purchaser (e.g., a purchaser who has not paid a bill by a deadline). In addition, the component can retrieve a history of the inventory in the freezer to check for any alerts to be sent to the purchaser application, allowing the component to provide a warning to a purchaser about expired or potentially tampered-with items before the freezer is unlocked.

In decision block 315, if both identifiers were verified, the component continues at block 325, else the component rejects the transaction and sends an error message to the purchaser at block 320. In some embodiments, the error message can relay what caused the error and prompt the purchaser to correct the problem and retry. If the purchaser wishes to continue, they may restart the process by resending the identifiers to the server again. In block 325, the component authorizes the transaction and sends a verification message to the purchaser application. In some embodiments, the verification message can also contain any relevant alerts related to items within the freezer. In block 330, the component sends an unlock signal to the freezer computer and then completes the authorization.

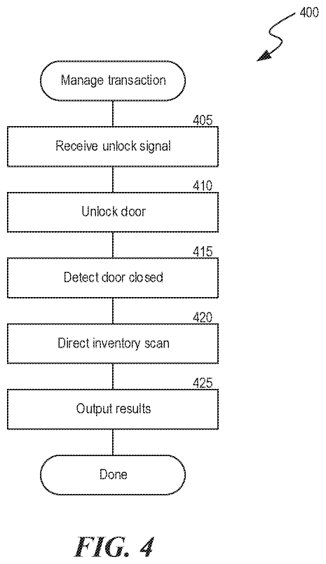

FIG. 4 is a flow diagram of a component for managing a transaction with the freezer in some embodiments of the ITC system. The manage transaction component 400 can be executed by the freezer computer after the server sends an unlock signal. At block 405, the component receives the unlock signal. At block 410, the component unlocks a door of the freezer. With the door unlocked, the purchaser has access to the inventory in the freezer and may select one or more items for purchase, remove the items, and walk away.

In block 415, the component detects that the door is closed. In one embodiment, the door closing may be mechanically automated when the purchaser walks away. For example, the door may be mechanically loaded such that it automatically closes when a purchaser is not holding it open. In another embodiment, the purchaser may be required to manually shut the door. Further, in another embodiment, if the door is unlocked but never opened, the component may consider the door to be closed after a certain amount of time (e.g., one minute). Doing so can reduce the likelihood that the door is left unlocked by a purchaser who disengages before completing the transaction, which could result in the purchaser being billed when someone else discovers the door is unlocked. At block 415, the component also ensures that the door is locked. In some embodiments, the door can be equipped with an automatic locking mechanism that locks the door when the door is shut. In other embodiments, the component can direct an electronic locking mechanism to lock the door. For example, if the door is not opened, the component may direct the freezer to lock the door after a certain amount of time, or the freezer may automatically lock the door after a certain amount of time.

At block 420, the component directs an inventory scan by directing one or more scanners to conduct a scan of the freezer to generate an inventory of items still in the freezer. For example, the component can direct one or more RFID readers to generate a list of RFID tags attached to items in the freezer to generate the inventory. Alternatively, or additionally, the one or more scanners can be a computer vision system, laser scanners, scales attached to shelves, or some combination of scanners, configured for generating the inventory in the freezer. At block 425, the component outputs the results, sends them to the server, and completes the transaction.

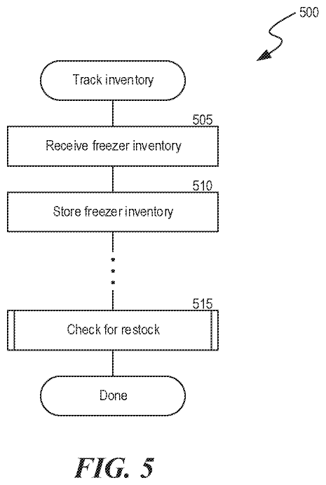

FIG. 5 is a flow diagram of a component for tracking a freezer's inventory in some embodiments of the ITC system. The track inventory component 500 can be executed by the server after the freezer computer sends the inventory. At block 505, the component receives the inventory from the freezer computer. In block 510, the component stores the freezer inventory. As FIG. 5 further illustrates, the component can continue into function block 515 to call one or more of the various functions performed using the inventory. For example, at function block 515, the component can check for restock. In other embodiments, at function block 515, the component can check for expired items, check for new items, check for removed items, etc., or any combination of these functions, before completing process 500. Alternatively, these and other functions can be called at different times, allowing the component to complete after block 510.

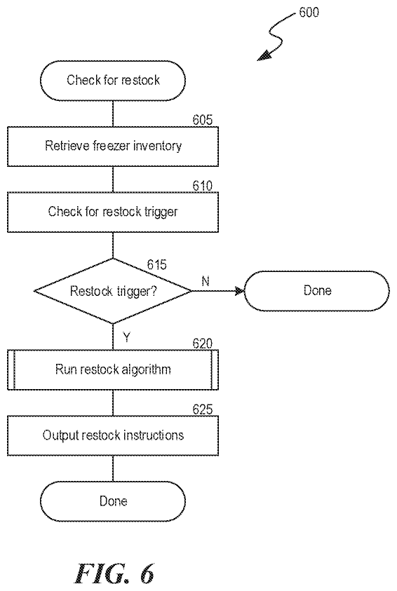

FIG. 6 is a flow diagram of a component for checking whether to restock the freezer in some embodiments of the ITC system. The check for restock component 600 can be executed by the server after the server receives and archives a freezer inventory. By prompting the component after every transaction, the system can ensure that a restock shipment is put together automatically as soon as the freezer count of any individual item falls below a threshold. Alternatively, the component can be prompted periodically (e.g. once per day, once per week, etc.). Once prompted, at block 605, the component retrieves the freezer inventory. At block 610, the component checks for a restock trigger. In some embodiments, the restock trigger can be any item freezer count falling below a preset threshold. For example, the restock trigger may check whether any item has less than three in the inventory. Alternatively, it may check different items for varied thresholds, for example whether item X has less than two in stock or item Y has less than four. In other embodiments, the restock trigger may be a timed event (e.g., every two weeks). In still other embodiments, the restock trigger can be a combination of the two, such that the trigger is every two weeks or when an item freezer count falls below a preset threshold.

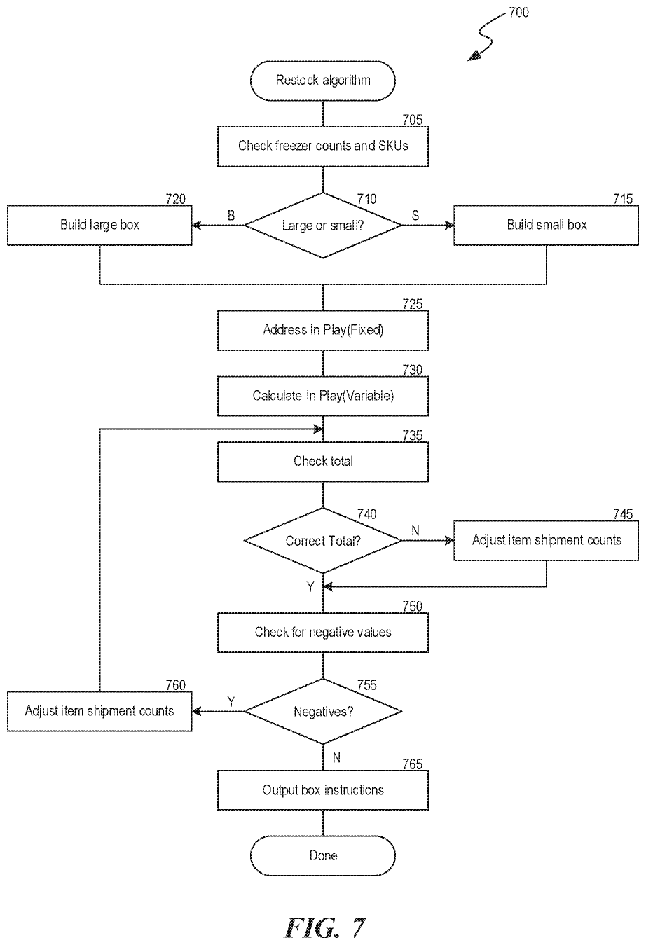

In decision block 615, if a restock trigger was indicated, the component continues at function block 620, else the component completes the check for restock. At function block 620, the component executes a restocking algorithm, described in more detail below with respect to FIG. 7. At block 625, the component outputs restock instructions for compiling a restocking shipment box. The output can be a printout or text file to be used by a human in packing a restocking shipment or can be computer-executable instructions that can be executed by an automated system to pack a restocking shipment. Further, in some embodiments, the output may be an order sheet forwarded to the freezer manager for review. After the instructions are output, the component completes the check for restock.

FIG. 7 is a flow diagram illustrating an example of a component for determining what items to include in a restocking shipment inventory in some embodiments of the ITC system. The restock algorithm component 700 can be executed by the server whenever the component determines a restock is necessary in decision block 615 (FIG. 6). At block 705, the component begins by checking the freezer counts and the stock keeping units (SKUs) for items in the inventory, as well as the maximum inventory count for the freezer.

An SKU is an identification, usually alphanumeric, of a particular item that allows it to be tracked for inventory and restocking purposes. In one embodiment, the system 100 makes use of three SKUs: Not in Play, In Play(Variable), and In Play(Fixed). Items assigned a Not in Play SKU will not be incorporated into a restocking package. An item present in the freezer may have this SKU assigned to it if, for example, the freezer manager has indicated they do not want any more of the item. An item assigned an In Play(Variable) SKU will be considered for the restocking package based on past sales of the item. In one percentage model, for example, if the item constitutes a large percentage of the sales at a given location, more of the item will be included in the restocking package. In some embodiments, the In Play(Variable) items are subject to machine learning and/or data mining algorithms that attempt to predict the sales of items in a given location. Finally, an item with an In Play(Fixed) SKU will be included in a restocking package to return the item to a preset quantity. For example, an item may be set to return to eleven counts of the item with every restocking shipment.

“At decision block 710, if sending a large box of inventory would overstock the freezer, then the component continues at block 715, else the component continues at block 720. The component determines whether a large box would overstock the freezer by checking whether I_{C}+R≤I_{M} is satisfied, where I_{C} is the current inventory, R is the total item shipment count included in a large restocking box, and I_{M} is the maximum inventory the freezer can hold. At block 715, the component designates to build a small box. At block 720, the component designates to build a large box. At block 725, the component addresses items with an In Play(Fixed) SKU. As described above, if an item has a freezer count of four and a fixed amount of eleven, seven of that item will be included in the restocking box. At block 730, the component calculates the In Play(Variable) item shipment counts to include. This calculation can follow a model based on percentages of past sales or can make use of various machine learning and data mining techniques to predict which items will be more in demand, augment item-variety in a given location, and predictively introduce newly created items into the location. Once the In Play(Variable) items have been selected, the component continues with a number of checks.

At block 735, the component checks the total to ensure that the total number of items is the total number allocated for the box (such that the box is full). This may not be satisfied, for example, due to rounding in the In Play(Variable) calculations, leaving the box overfilled or underfilled. At decision block 740, if the box has a correct total, the component continues at block 750, else the component continues at block 745. At block 745, the component adjusts item shipment counts such that the total items match the total number allocated for the box as set after decision block 710. At block 750, the component checks for negative values in the item shipment counts for the box. At decision block 755, if there were no negative values, the component continues at to box 765; else the component continues at block 760. At block 760, the component adjusts the item shipment counts such that there are no negative values assigned for the items in the box, then loops back to block 735 to check the total again. After the totals for items allocated to the box and the total items allowed per box match without any negative values being included, at block 765 the component outputs box instructions and completes the restocking algorithm, corresponding to block 625 in FIG. 6.

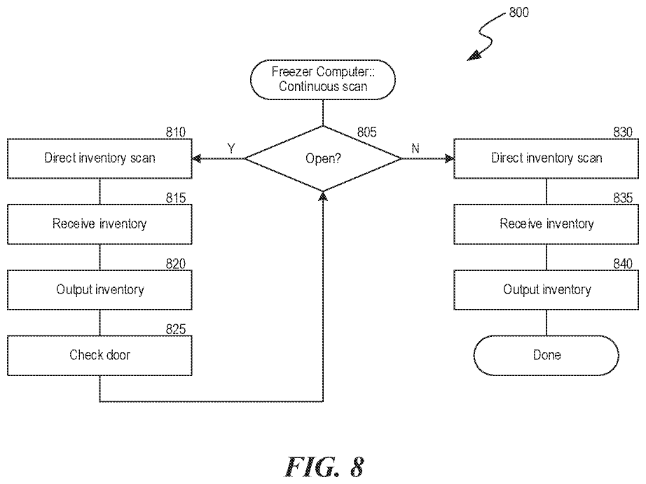

Returning to the freezer computer, FIG. 8 is a flow diagram illustrating a component for conducting a continuous scan inventory in some embodiments of the ITC system. Among other things, executing a continuous scan allows the freezer computer and/or server to detect when an item is removed and replaced into the freezer and/or when a new item is added to the freezer. By detecting new or potentially altered items, the freezer computer and/or server can alert purchasers about the presence of the offending objects, warning them, for example, not to consume the item. In addition, by detecting when purchasers remove and replace an item, the freezer computer and/or server may track a purchaser's interests for use in data mining and machine learning processes, detect when a purchaser is trying to steal by removing food and replacing the packaging, or detect various other purchaser activities.

The continuous scan component 800 is executed by the freezer computer after the door to the freezer has been unlocked. At decision block 805, if the door is open, the component begins a looping track at block 810, else the component continues at block 830. At block 810, the component directs an inventory scan by directing one or more scanners to conduct a scan of the freezer and generate an inventory of items contained in the freezer. At block 815, the component receives the inventory, and at block 820, the component outputs the inventory and sends it to the server.

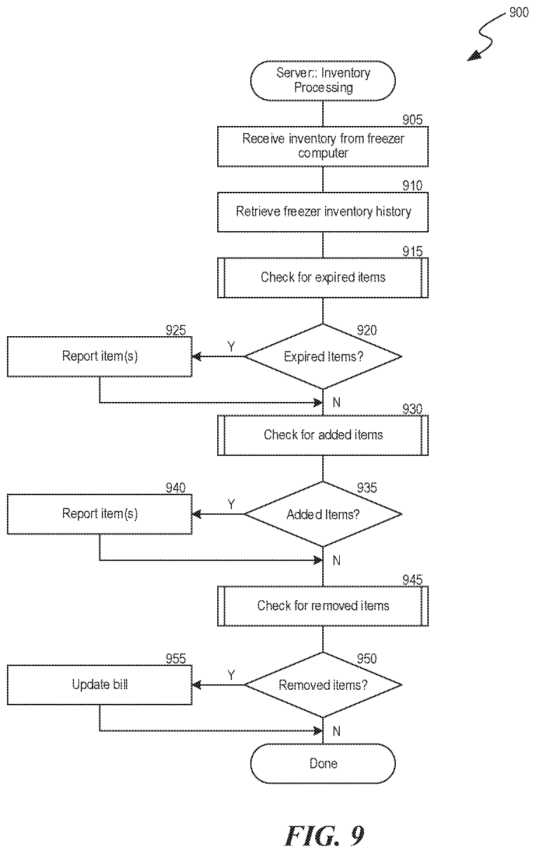

In an alternative embodiment, once the inventory is received from the one or more scanners, the freezer computer can execute component 900 described in detail below with respect to FIG. 9. In the illustrated embodiment, the component 900 is reserved for the server, and the component 800 continues on to block 825.

At block 825, the component checks the door to determine whether the door is still open. At decision block 805, if the door is still open, the component repeats the loop beginning again at block 810; else the component continues at block 830 and completes one more scanning process before completing the continuous scan. The scanning process set out in blocks 830, 835, and 840 corresponds to the process set out in blocks 810, 815, and 820, respectively.

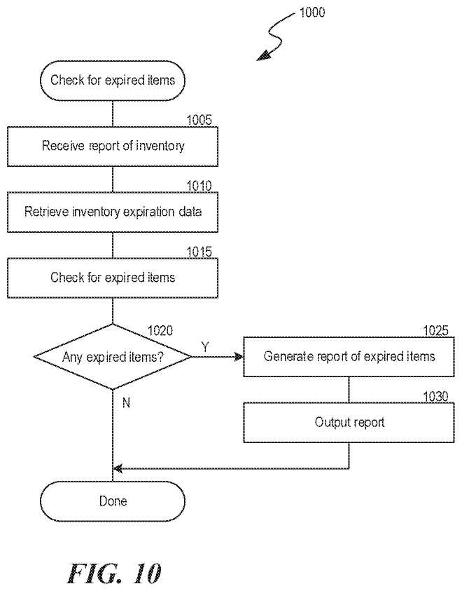

FIG. 9 is a flow diagram of a component for processing the inventory results from a continuous scan inventory in some embodiments of the ITC system. The inventory processing component 900 is executed by the server after receiving an inventory message from the freezer computer executing a continuous scan. However, the inventory processing component can also be executed after the singular inventory scan conducted in the manage purchase component 400 described above with respect to FIG. 4. Regardless of timing, at block 905, the component receives the inventory from the freezer computer. At block 910, the component retrieves the freezer's inventory history from the inventory database. With the two records, the component continues at function block 915 to check for expired items in the inventory, illustrated in the flow diagram of FIG. 10.

FIG. 10 is a flow diagram illustrating a component for checking for expired items in some embodiments of the ITC system. The check for expired items component 1000 is executed by the server after receiving the inventory from the freezer computer. At block 1005, the component receives the report of inventory. At block 1010, the component retrieves expiration data on the designated consumption date for items in the remaining inventory. At block 1015, the component checks for expired items in the inventory. At decision block 1020, if there are expired items remaining in the inventory, the component continues at block 1025 to generate a report of the expired items, else the component completes. At block 1030, the component 1000 outputs the report, completes, and returns to component 900.

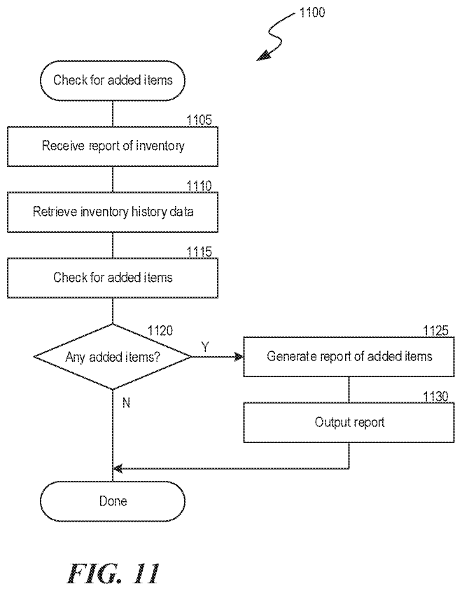

Returning to FIG. 9, the component 900 continues at to decision block 920. At decision block 920, if there were expired items identified by the component 1000, the component 900 reports the items at block 925 before moving on to function block 930. For example, the report can be sent to the freezer manager to prompt the freezer manager to remove the items. Else, the component continues at function block 930 to check for added items in the freezer, illustrated in the flow diagram of FIG. 11.

FIG. 11 is a flow diagram illustrating a component for checking for added items in some embodiments of the ITC system. The check for added items component 1100 is executed by the server after receiving the inventory from the freezer computer. At block 1105, the component receives a report of the inventory, and at block 1110, the component retrieves inventory history data. At block 1115, the component checks for added items by checking for items present in the current inventory that were not present in the previous inventory. At decision block 1120, if there are added items in the inventory, the component continues at block 1125, else the component completes and returns to component 900. At block 1125, the component generates a report of the added items, and at block 1130, the component 1100 outputs the report, completes, and returns to component 900 in FIG. 9.

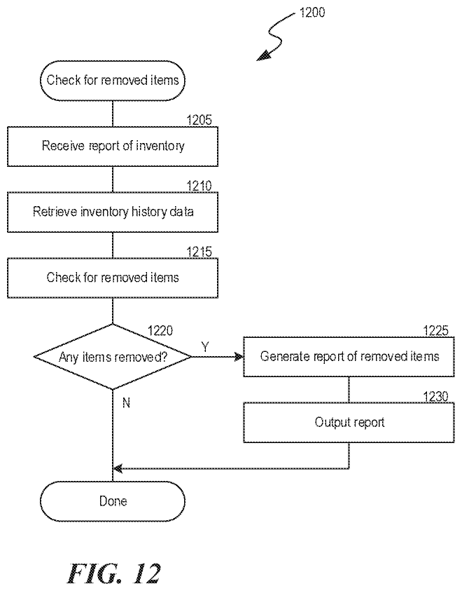

Returning to FIG. 9, the component 900 uses the result of function block 930 to proceed to decision block 935. In decision block 935, if there were any added items in the inventory, the component reports the items at block 940 before continuing to function block 945; else the component continues at function block 945. For example, the report generated at block 940 can be sent to the freezer manager to prompt the freezer manager to remove the offending items. At function block 945, the component checks for removed items, illustrated in the flow diagram of FIG. 12.

FIG. 12 is a flow diagram illustrating a component for checking for removed items in the freezer inventory in some embodiments of the ITC system. The check for removed items component 1200 is executed by the server after receiving the inventory from the freezer computer and is called by function block 945 in FIG. 9. At block 1205, the component receives a report of the inventory, and at block 1210, the component retrieves inventory history data. At block 1215, the component checks for removed items by comparing the two records. At decision block 1220, if there were new items, the component continues at block 1225, else the component 1200 completes and returns to the component 900. At block 1225, the component generates a report of the removed items, and at block 1230, the component 1200 outputs the report, completes, and returns to component 900 in FIG. 9.

Returning to FIG. 9, at decision block 950, the component checks whether any items were removed using the report from block 1230. If there were, the component continues at block 955, else the component completes. In block 955, the component updates a bill. In one embodiment, the bill can be associated with a specific purchaser, such that the purchaser that unlocked the freezer is directly charged for the transaction. In another embodiment, the bill can be sent to the freezer manager, for example when a company is subsidizing items taken from the freezer. After the bill is updated in block 955, the component completes the inventory processing. In some embodiments, the server can execute component 900 in a loop as the next inventory is received from the freezer computer while the door is open.

In addition to the processes illustrated in the figures discussed above, the server and/or freezer computer can retrieve the inventory for various other functions. For example, in one embodiment a purchaser can view a menu of the current freezer inventory via the purchaser application. In this embodiment, the purchaser application sends a request to the server, which, upon receiving the request, retrieves the current inventory and sends it back to the purchaser application for display. In some embodiments, the menu further comprises the nutritional information of the items on the menu, the ingredients of items on the menu, allergy information for items on the menu, item cook times, etc. In another embodiment, the server can track a purchaser's purchase history to display a history of the nutritional values of the items they consumed, make recommendations on improving their nutrient intake, and/or recommend similar items they may be interested in based on the purchases of similarly situated purchasers.

Further, the server can execute various machine learning and data mining functions with information and metadata related to the inventory in a freezer, inventory trends in a freezer, inventory trends across freezers, and/or other information. In one embodiment, for example, the server can apply machine learning techniques to a record of the inventory at a freezer to identify trends in purchasing (e.g., more soup is purchased in winter), which can then be used to predictively restock the freezer. In another embodiment, the server can make use of information and metadata on purchasers (e.g., demographic information), which can be used by the server to mine for purchase trends related to demographics to predict restocking shipments and to predictively stock new freezer locations based on expected users.

From the foregoing, it will be appreciated that specific embodiments of the invention have been described above for purposes of illustration but that various modifications may be made without deviating from the scope of the invention. Accordingly, the invention is not limited except as by the appended claims.

I/We claim:

1. A computing system for conducting a transaction at a freezer that contains items, the computing system comprising:
one or more computer-readable storage mediums storing computer-executable instructions for controlling the computing system to:
receive an unlock signal sent from a server in communication with a purchaser;
direct the unlocking of a door of the freezer;
receive an indication that the door of the freezer is closed;
direct one or more scanners to conduct a scan of the freezer to generate an inventory of items contained in the freezer;
receive the inventory from the one or more scanners; and
send the inventory to the server so that the server can determine whether an item was removed from the freezer while the door was unlocked; and
one or more processors for executing the computer-executable instructions stored in the one or more computer-readable storage mediums.

2. The computing system of claim 1 wherein the one or more scanners include one or more radio-frequency identification (RFID) scanners.

3. The computing system of claim 1 wherein the inventory is a list of radio-frequency identification (RFID) tags identified within the freezer by the one or more scanners.

4. The computing system of claim 1 wherein the instructions further control the computing system to:
detect when the door of the freezer is opened;
direct the one or more scanners to scan contents of the freezer while the door is opened; and
detect when an item previously removed from the freezer has been placed into the freezer.

5. The computing system of claim 4 wherein the scan occurs repeatedly while the door is open.

6. The computing system of claim 4 wherein the instructions further control the computing system to communicate to the purchaser an alert warning the purchaser not to consume the item placed into the freezer.

7. A method performed by a computing system for conducting a transaction at a freezer, the method comprising:
receiving a signal to unlock a door of the freezer from a server in communication with a purchaser;
directing the unlocking of the door of the freezer;
receiving an indication that the door of the freezer is closed;
directing one or more scanners to conduct a scan of the freezer to generate an inventory of items contained in the freezer;
receiving the inventory from the one or more scanners; and
sending the inventory to the server so that the server can determine whether an item was removed from the freezer while the door was unlocked.

8. The method of claim 7 wherein the freezer comprises an interior including one or more shelves configured to carry items, one or more radio-frequency identification (RFID) scanners within the interior, and a communication element.

9. The method of claim 7 wherein the one or more scanners include radio-frequency identification (RFID) readers configured to identify RFID tags within the freezer when directed to scan the freezer.

10. The method of claim 7 wherein the method further comprises sending a unique freezer identifier to a purchaser through a wireless communication, the freezer identifier specifying which freezer the purchaser is interacting with.

11. The method of claim 7 wherein the method further comprises providing a unique freezer identifier to a purchaser, the freezer identifier specifying which freezer the purchaser is interacting with.

12. The method of claim 11 wherein the unique freezer identifier is a QR code assigned to the freezer.

13. The method of claim 7 further comprising:
detecting when the door of the freezer is open;
repeatedly scanning the freezer to detect contents of the freezer using the one or more scanners; and
detecting when a new item has been placed into the freezer by identifying the new item as not having been present in a previous scan.

14. The method of claim 13 further comprising alerting a purchaser to the presence of the new item in the freezer in order to warn against consuming the new item.

15. A computing system for authorizing a transaction at a freezer containing items, the computing system comprising:
one or more computer-readable storage mediums storing computer-executable instructions for controlling the computing system to:
receive a freezer identifier and a purchaser identifier from a computer device controlled by a purchaser, the freezer identifier specifying which freezer the purchaser is interacting with and the purchaser identifier specifying which purchaser is interacting with the freezer;
verify the freezer identifier to ensure that the purchaser is interacting with a valid freezer;
verify the purchaser identifier to ensure that the purchaser is authorized for transactions with the freezer;
send an unlock signal to the freezer so that the freezer will unlock a door so that the purchaser can remove items for purchase; and
receive a message from the freezer specifying an inventory in the freezer after the door was shut; and
a processor for executing the computer-executable instructions stored in the one or more computer-readable storage mediums.

16. The computing system of claim 15 wherein the freezer comprises a main storage area, three radio-frequency identification (RFID) scanners inside the main storage area, one or more shelves inside the main storage area for carrying inventory, and a communication element for communicating with the computing system.

17. The computing system of claim 15, wherein:
the computing system further includes an inventory consumption date database storing a record of consumption dates for items in the freezer and a status for items in the freezer; and
the instructions further control the computing system to:
check the message for inventory items past their consumption date;
update the status of any item that is past the consumption date for the item; and
send a “do not consume” message to a purchaser application identifying the item past its consumption date after receiving the freezer identifier.

18. The computing system of claim 15, wherein:
the computing system further includes an inventory database storing a history of the inventory in the freezer; and
the instructions further control the computing system to:
calculate a change in the inventory using the message received from the freezer and the history of the inventory in the freezer; and
identify when an item has been added to the freezer between a previous message and the message based on the change in freezer inventory.

19. The computing system of claim 18, wherein the instructions further control the computing system to send a “do not consume” message to a purchaser identifying the item that was added to the freezer.

20. The computing system of claim 15, wherein:
the computing system further includes an inventory database storing a history of the inventory in the freezer; and
the instructions further control the computing system to:
calculate a change in the inventory using the message received from the freezer and the history of the inventory in the freezer; and
assign a value to the change in freezer inventory based on pricing information.

21. The computing system of claim 20, wherein the instructions further control the computing system to:
bill a purchaser identified by the purchaser identifier for an amount corresponding to the value; and
send a receipt message to a purchaser application communicating the value.

22. The computing system of claim 20, wherein the instructions further control the computing system to:
bill a freezer manager for an amount corresponding to the value; and
send the freezer manager a receipt with the purchaser identifier and the value.

23. A method performed by a computing system for authorizing a transaction at a freezer, the method comprising:
receiving a freezer identifier and a purchaser identifier from a computer device controlled by a purchaser, the freezer identifier specifying which freezer the purchaser is interacting with and the purchaser identifier specifying which purchaser is interacting with the freezer;
verifying the freezer identifier to ensure that the purchaser is interacting with a known freezer;
verifying the purchaser identifier to ensure that the purchaser is authorized for transactions with the freezer; and
sending an unlock signal to the freezer so that the freezer will unlock a door so that the purchaser can open the door and remove items for purchase.

24. The method of claim 23 wherein the method further comprises receiving a message from the freezer specifying an inventory in the freezer after the door was shut.

25. The method of claim 24 wherein the method further comprises:
retrieving a consumption date for each item in the inventory from an inventory database;
comparing a current date to the consumption date for each item; and
reporting any item for which the consumption date is earlier than the current date.

26. The method of claim 24 wherein the method further comprises:
retrieving a previous inventory from an inventory database;
calculating an increase in the inventory using the message received from the freezer and the previous inventory to identify new items; and
reporting the new items to a freezer manager to alert the freezer manager to remove the new items before a second purchaser consumes them.

27. The method of claim 26 further comprising:
receiving the freezer identifier and a second purchaser identifier from a second computer device controlled by the second purchaser; and
sending an alert to the second computer device, wherein the alert warns the second purchaser of the presence of the new items and warns against consuming the new items.

28. The method of claim 24 wherein the method further comprises:
retrieving a previous inventory from an inventory database;
calculating a reduction in freezer inventory using the message received from the freezer and the previous inventory to identify removed items; and
assigning a value to the reduction to be used in billing for the transaction.

29. The method of claim 28 wherein the method further comprises charging the purchaser for the value.

30. The method of claim 28 wherein the method further comprises charging a freezer manager for the value.
